(19) United States
(12) Patent Application Publication
(10) Pub. No.: US 2021/0127875 A1
(43) Pub. Date: May 6, 2021

(54) FOLDABLE UTENSIL

(71) Applicant: THE FINAL CO. LLC, Santa Fe, NM (US)

(72) Inventors: Emma R. Cohen, Santa Barbara, CA (US); Matthew D. Hantke, Ventura, CA (US)

(21) Appl. No.: 16/669,196

(22) Filed: Oct. 30, 2019

(51) Int. Cl. A47G 21/02; A47G 21/04; B26B 3/02

(52) U.S. Cl. CPC A47G 21/02; A47G 2021/002; B26B 3/02; A47G 21/04

(57) ABSTRACT

A foldable utensil includes a foldable stem member and a working member. The foldable stem member includes a first end, a second end, and an elongated body extending between the first end and the second end. The elongated body includes at least a first segment and a second segment operably coupled with and foldable relative to the first segment. The working member is operably coupled with and is foldable relative to the second end of the foldable stem member. The foldable utensil is positionable in a first, unfolded configuration and a second, folded configuration.

### FIELD OF THE DISCLOSURE

The present disclosure generally relates to utensils and, more particularly, to reusable utensils that can be folded in stored in a storage case.

### BACKGROUND

Every year, billions of plastic utensils are used in the United States. These utensils are oftentimes disposed of after a single use, and frequently are not recycled. As such, the utensils become a source of plastic pollution. Such utensils may wind up in unintended environments such as waterways and large bodies of water, upon which animals may incorrectly confuse them as food. Aside from increased environmental waste, animals that ingest these utensils may suffer from related health issues.

With the increase in awareness of the environmental toll that disposable utensils have on the environment, some consumers have turned to providing their own reusable utensils. However, these utensils are oftentimes made from metal and/or glass, and as such, may be burdensome to carry and may incur damage. A protective case may be desired to ensure the utensil is sanitary and to protect the utensil from potential damage. Such cases are oftentimes bulky and space-consuming.

### SUMMARY

In accordance with one aspect, a foldable utensil includes a foldable stem member and a working member. The foldable stem member includes a first end, a second end, and an elongated body extending between the first end and the second end. The elongated body includes at least a first segment and a second segment operably coupled with and foldable relative to the first segment. The working member is operably coupled with and is foldable relative to the second end of the foldable stem member. The foldable utensil is positionable in a first, unfolded configuration and a second, folded configuration.

In some examples, the foldable stem member includes an exterior body defining an interior cavity and a flexible member at least partially disposed within the interior cavity. The first and the second segments may be insertably coupled with each other. Alternatively, the first and the second segments may be adapted to abut each other when the foldable utensil is positioned in the unfolded configuration. In other examples, the foldable stem member includes a flexible member having integrally formed first and second segments as well as a first folding region at a first junction between the first and the second segments.

In some examples, the flexible member may include an elastic member operably coupled with the working member. The flexible member exerts an elastic force on the working member. In some forms, the working member may be in the form of a fork, a spoon, a spork, a knife, a splayd, a spife, or a hand tool. Other examples are possible.

In accordance with a second aspect, a foldable utensil includes a foldable stem member, a working member, and a flexible member. The foldable stem member includes an elongated body that defines an interior cavity and has a first end and a second end. The elongated body further includes at least a first segment and a second segment operably coupled with and foldable relative to the first segment. The working member is operably coupled with and foldable relative to the second end of the elongated body. The flexible member is at least partially disposed within the interior cavity of the elongated body and is operably coupled with the first end of the elongated body. The foldable utensil is positionable in a first, unfolded configuration and a second, folded configuration.

In accordance with yet another aspect, a reusable utensil system includes a foldable utensil and a storage case. The foldable utensil includes a foldable stem member and a working member. The foldable stem member includes a foldable stem member and a working member. The foldable stem member includes a first end, a second end, and an elongated body extending between the first end and the second end that includes at least a first segment and a second segment operably coupled with and foldable relative to the first segment. The working member is operably coupled with and foldable relative to the second segment of the foldable stem member. The foldable utensil is positionable in a first, unfolded configuration and a second, folded configuration. The storage case defines an interior cavity capable of retaining the foldable utensil when the foldable utensil is positioned in the second, folded configuration.

### BRIEF DESCRIPTION OF THE DRAWINGS

The above needs are at least partially met through provision of a foldable utensil described in the following detailed description, particularly when studied in conjunction with the drawings, wherein:

FIG. 1 illustrates a top plan view of a first example foldable utensil having a first example working member and being positioned in a first unfolded configuration in accordance with various embodiments;

FIG. 2 illustrates an exploded view of the first example foldable utensil of FIG. 1 in accordance with various embodiments;

FIG. 3 illustrates a side elevation view of the first example foldable utensil of FIGS. 1 and 2 while transitioning to a second, folded configuration in accordance with various embodiments;

FIG. 4 illustrates a side elevation view of the first example foldable utensil of FIGS. 1-3 positioned in the second, folded configuration in accordance with various embodiments;

FIG. 5 illustrates a top plan view of a second example foldable utensil in accordance with various embodiments;

FIG. 6 illustrates a top plan view of a third example foldable utensil in a first configuration in accordance with various embodiments;

FIG. 7 illustrates a side elevation view of the third example expandable device of FIG. 6 in a second configuration in accordance with various embodiments;

FIG. 8 illustrates a top plan view of a second example working member in accordance with various embodiments;

FIG. 9 illustrates a top plan view of a third example working member in accordance with various embodiments;

FIG. 10 illustrates a top plan view of a fourth example working member in accordance with various embodiments;

FIG. 11 illustrates a top plan view of a fifth example working member in accordance with various embodiments;

FIG. 12 illustrates a top plan view of a sixth example working member in accordance with various embodiments;

FIG. 13 illustrates a perspective view of an example reusable utensil system using the example foldable utensil of FIGS. 1-12 and further including a case in accordance with various embodiments;

FIG. 14 illustrates a perspective view of the example reusable utensil system during insertion of the example foldable utensil in accordance with various embodiments;

FIG. 15 illustrates a top plan view of an example foldable utensil using a seventh example working member in accordance with various embodiments; and

FIG. 16 illustrates a view of the example foldable utensil and the example working member of FIG. 15 in accordance with various embodiments.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a reusable, foldable utensil is provided that may be positionable between a first, extended configuration for use as a utensil and a second, compact folded configuration for storage and for easy transportability via an accessory storage case. In some forms, the foldable utensil includes an external tube and a flexible and/or elastic internal tubing that is foldable. In the folded configuration, the utensil has an overall length that is reduced by approximately 25% to approximately 70% of the overall length of the utensil when in the extended configuration.

In some examples, the external tubing is provided in a number of discrete segments that are separable from each other and at least partially movable relative to the internal tubing. In some of these examples, the rigid segments are configured to, when coupled together, form a handle or stem of the utensil for grasping by the user. A storage case is additionally provided that can store the foldable utensil in the folded configuration, thereby resulting in a compact form that may be carried by a user.

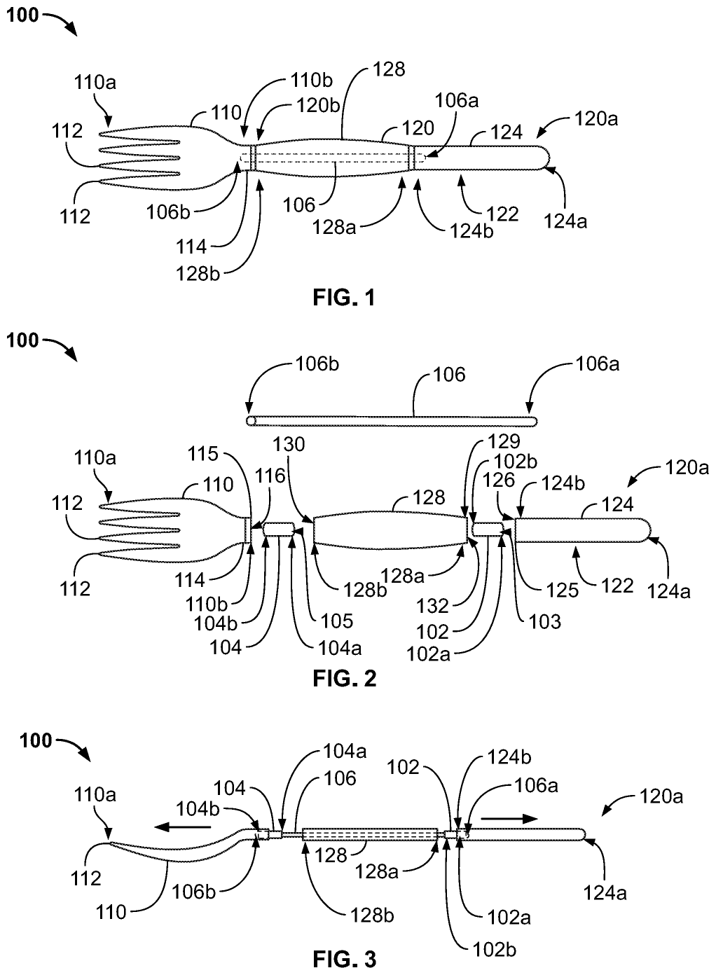

A first embodiment of a foldable utensil 100 is shown in FIGS. 1-4. Generally, the foldable utensil 100 includes a working member 110 and a foldable stem member 120. The working member 110 is in the form of a fork head 110 having a first end 110a and a second end 110b. The first end 110a of the fork head 110 includes a number of tines 112 used to grasp or puncture foodstuffs or other consumables. In some examples, the outermost tines are beveled to improve cutting ability. The second end 110b of the fork head 110 defines a generally tubular portion 114 having an opening 115 that defines an inner cavity 116 (FIG. 2). The working member 110 may be constructed from stainless steel or other similar suitable materials.

The foldable stem member 120 has a first end 120a and a second end 120b, and an elongated body 122 extending therebetween. In the illustrated example of FIGS. 1-4, the elongated body 122 is in the form of a first segment 124 having a first end 124a and a second end 124b and a second segment 128 having first and second ends 128a, 128b. The elongated body 122 is constructed from stainless steel or other similar suitable materials.

Generally speaking, the first segment 124 forms the first end 120a of the foldable stem member 120. The first segment 124 is a generally tubular, elongated member that has an opening 125 that defines an interior cavity 126. In some examples, the first end 124a of the first segment 124 is sealed or closed. The second segment 128 forms the second end 120b of the foldable stem member 120, and is also a generally tubular, elongated member. Both of the first and second end 128a, 128b of the second segment 128 include respective openings 129, 130 that define an interior cavity 132 extending between the first and second ends 128a, 128b of the second segment 128.

The foldable utensil 100 further includes a first insert 102, a second insert 104, and a flexible member 106. The first and second inserts 102, 104 are elongated, hollow members the define respective cavities 103, 105. The first insert 102 has a first end 102a and a second end 102b, and the second insert 104 has a first end 104a, and a second end 104b. In some examples, the first and second inserts 102, 104 are constructed from stainless steel or other suitable materials. Generally speaking, the first and second inserts 102, 104 are insertable into the inner cavities 116, 126, 132 of the working member 110, the first segment 124, and the second segment 128.

The flexible member 106 is constructed from a generally foldable or pliable material. In some examples, the flexible member 106 is in the form of a silicone member having elastic properties. In other examples, the flexible member 106 may be in the form of a bungee cord. Other examples of suitable materials are possible. The flexible member 106 may be generally hollow or solid. The flexible member 106 includes a first end 106a and a second end 106b. Generally speaking, the flexible member 106 is dimensioned to be disposed within the cavities 116, 126, 132 of the working member 110, the first segment 124, and the second segment 128 as well as the cavities 103, 105 of the first and second inserts 102, 104, respectively.

More specifically, the first and second ends 106a, 106b of the flexible member 106 are constructed from a stiffer material (e.g., a harder portion of silicone) than the remainder of the flexible member 106 while being dimensioned to be slightly larger than a dimension (e.g., a diameter) of the first and the second inserts 102, 104. Because the flexible member 106, and specifically, the first and second ends 106a, 106b thereof, are formed from a flexible material, the first and second ends 106a, 106b will deform upon being inserted into the cavities 103, 105 of the respective first and second inserts 102, 104. The first end 106a of the flexible member 106 is inserted into the cavity 103 of the first insert 102 from the second end 102b through the first end 102a. Upon inserting the first end 106a of the flexible member 106 through the first end 102a of the first insert 102, the first end 106a will expand to an non-deflected configuration, thereby forming a button-head that may not be pulled back through the cavity 103.

The first end 102a of the first insert 102 (and thus, the first end 106a of the flexible member 106) is then inserted into the opening 125 of the first segment 124 such that it is at least partially disposed within the interior cavity 126. The first insert 102 is dimensioned to form a friction-fit coupling with the first segment 124. In some examples, additional securing approaches such as cold welding may be used to secure the first insert 102 with the first segment 124. In such examples, the first segment 124 may include any number of breather holes (not illustrated) that allow the cold welding process to vent, thereby ensuring proper distribution of the material. Other examples are possible.

The second end 106b of the flexible member 106 is then inserted or threaded through the opening 129 at the first end 128a of the second segment 128 through the opening 130 at the second end 128b of the second segment 128. The opening 129 is dimensioned to be larger than the second end 102b of the first insert 102, and as such, the second end 102b of the first insert 102 is insertable into the interior cavity 132 of the second segment 128. As a result, and as illustrated in FIG. 1, the first end 128a of the second segment 128 may abut or be positioned at or near the second end 124b of the first segment 124.

The second end 106b of the flexible member 106 is inserted into the cavity 105 of the second insert 104 from the first end 104a through the second end 104b. Upon inserting the second end 106b through the second end 104b of the second insert 104, the second end 106b expands to a non-deflected configuration, thereby forming a button-head that may be pulled back through the cavity 105.

The second end 104b of the second insert 104 (and thus, the second end 106b of the flexible member 106) is then inserted into the opening 115 of the working member 110 such that it is at least partially disposed within the interior cavity 116. The second insert 104 is dimensioned to form a friction-fit coupling with the working member 110. In some examples, additional securing approaches such as cold welding may be used to secure the second insert 104 with the working member 110. In such examples, the working member 110 may include any number of breather holes (not illustrated) that allow the cold welding process to vent, thereby ensuring proper distribution of the material. Other examples are possible.

The opening 130 is dimensioned to be larger than the first end 104a of the second insert 104, and as such, the first end 104a of the second insert 104 is insertable into the interior cavity 132 of the second segment 128. As a result, and as illustrated in FIG. 1, the second end 128b of the second segment 128 may abut or be positioned at or near the second end 110b of the working member 110.

In some examples, when constructed, the foldable utensil 100 does not include any openings that extend through the working member 110. In some examples, however, it may be desired to provide an opening in the working member 110 that connects the working member 110 with the interior cavities 132, 126. It is appreciated that the foldable utensil 100 may be constructed in an opposite procedure where the second end 106b of the flexible member is inserted through the second insert 104, then through the second end 128b of the second segment 128 and through the first end 128a thereof. Other examples are possible.

As illustrated in FIG. 1, when constructed, the foldable utensil 100 is positioned in a first, unfolded configuration where a user may use the utensil for food consumption. The components (e.g., the first and the second inserts 102, 104, and/or the openings 125, 129, 130, 115) may have aligning features such as notches, latches, tabs, and the like (not illustrated) that properly position and align the foldable utensil 100. In some examples, when the foldable utensil 100 is positioned in the unfolded configuration, the flexible member 106 may be stretched and/or tensioned such that the first and the second ends 106a, 106b are urged towards each other. In some examples, however, the flexible member 106 may not be in a tensioned configuration when the foldable utensil 100 is in the unfolded configuration.

Because the first and second ends 106a, 106b are coupled with the first and second inserts 102, 104, respectively, which are in turn coupled with the first segment 124 and the working member 110, the first segment 124 and the working member are pulled or urged towards the second segment 128, thereby retaining the foldable utensil 100 in the unfolded configuration. Additionally, the insertable coupling between the second end 102b of the first insert and the first end 128a of the second segment 128 prevents the foldable utensil 100 from inadvertently bending or folding during use. Similarly, the insertable coupling between the first end 104a of the second insert 104 and the second end 128b of the second segment 128 also prevents the foldable utensil 100 from inadvertently bending or folding during use.

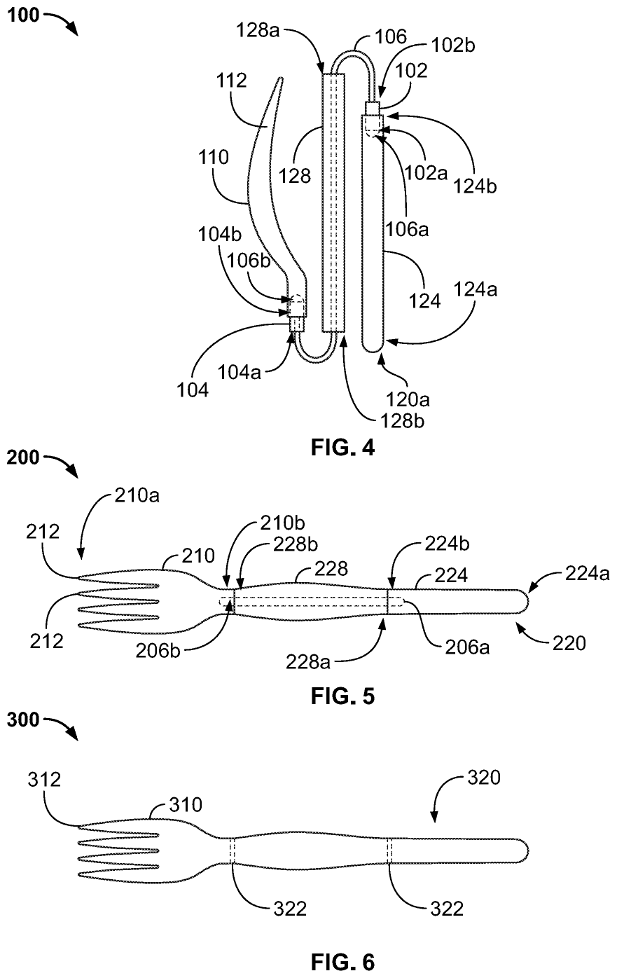

As illustrated in FIG. 3, a user may grasp the working member 110 and the first segment 124 and pull each in opposing directions. Doing so decouples the second end 102b of the first insert 102 from the first end 128a of the second segment 128, and further decouples the first end 104a of the second insert 104 from the second end 128b of the second segment. As illustrated in FIG. 4, the foldable utensil 100 may then be positioned in a second, folded configuration for storage.

The foldable utensil described herein may be provided in any number of alternative designs. For example, FIG. 5 illustrates a second example foldable utensil 200. It is appreciated that the foldable utensil 200 illustrated in FIG. 5 may include similar features to the foldable utensil 100, and accordingly, elements illustrated in FIG. 5 are designated by similar reference numbers indicated in the embodiment illustrated in FIGS. 1-4 increased by 100. Accordingly, these features will not be described in substantial detail. Further, it is appreciated that any of the elements described with regards to the foldable utensil 100 may be incorporated into the foldable utensil 200.

In this embodiment, the foldable utensil 200 does not include inserts that are inserted into the working member 210, the first segment 224, or the second segment 228. Rather, the first and the second ends 206a, 206b of the flexible member 206 are coupled directly with the first segment 224 and the working member 210 via any number of suitable approaches such as, for example, a friction fit connection, a threaded connection, adhesives, and the like. Other examples are possible. Accordingly, in this configuration, when the foldable utensil 200 is positioned in the unfolded configuration, the second end 224b of the first segment 224 simply abuts the first end 228a of the second segment 228. Similarly, the second end 228b of the second segment 228 simply abuts the second end 210b of the working member 210.

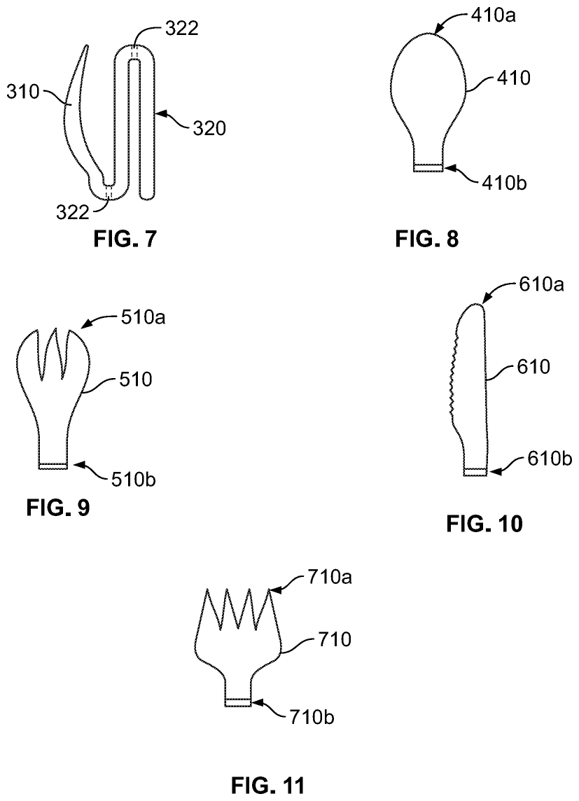

With reference to FIGS. 6 and 7, a third example foldable utensil 300 is provided. It is appreciated that the foldable utensil 300 illustrated in FIGS. 6 and 7 may include similar features to the foldable utensils 100, 200, and accordingly, elements illustrated in FIGS. 6 and 7 are designated by similar reference numbers indicated in the embodiment illustrated in FIGS. 1-5 increased by 100 and 200, respectively. Accordingly, these features will not be described in substantial detail. Further, it is appreciated that any of the elements described with regards to the foldable utensils 100 and 200 may be incorporated into the foldable utensil 300.

In this embodiment, the foldable utensil 300 is in the form of a flexible member that itself is foldable. Put differently, the foldable utensil 300 does not include a separate tubular shell member constructed of a rigid material. Rather, the foldable stem member 320 may include segments or junction points 322 that allow the foldable utensil 320 to be positioned into the folded configuration. In some examples, the junction points 322 may be areas of greater flexibility, may have a smaller diameter or thickness than the remainder of the foldable utensil 300. Other examples are possible.

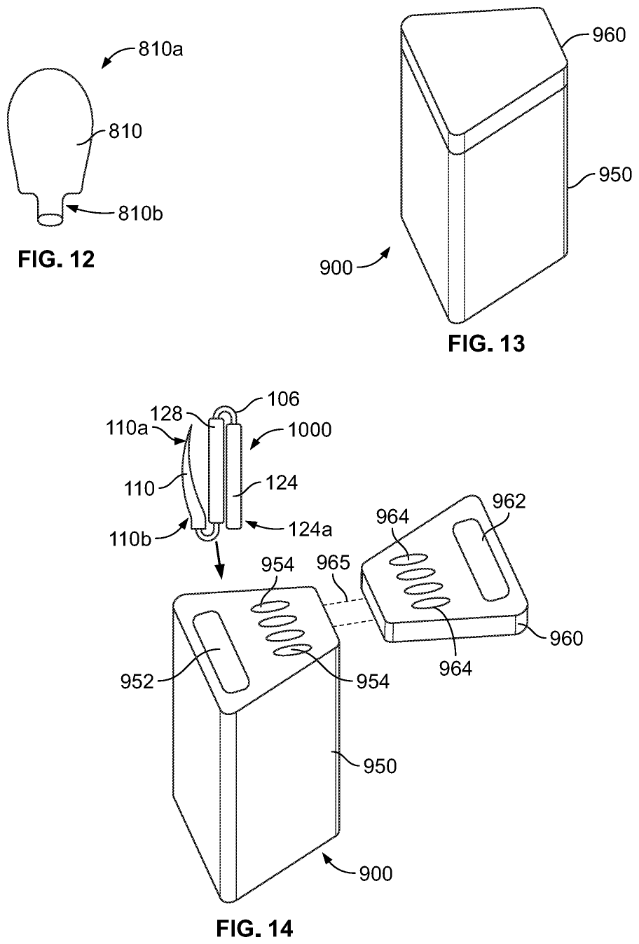

Turning to FIGS. 8-12, in some examples, the foldable utensil may be provided with different working members having similar features as the working members 110, 210, 310. For example, FIG. 8 illustrates an alternative working member 410 in the form of a spoon, FIG. 9 illustrates a working member 510 in the form of a spork, FIG. 10 illustrates a working member 610 in the form of a knife, FIG. 11 illustrates a working member 710 in the form of a splayd, and FIG. 12 illustrates a working member 810 in the form of a spife. Other examples, such as hand tools (e.g., screwdriver heads, a bottle opener, a can opener, a colander, a measuring cup, and the like are possible. In some of these examples, the working member may be removable to allow different working members to be coupled to the foldable utensil. For example, when a second insert 104 is provided, the second insert 104 may be removably coupled with the working member (e.g., via a threaded connection) to allow for quick replacement thereof. Other examples are possible.

Turning now to FIGS. 13 and 14, an example reusable utensil system 900 is provided. Generally speaking, the reusable utensil system 900 includes a storage case 950 and any one or ones of the previously described foldable utensils 100, 200, 300. The storage case 950 includes a lid 960 which, in the illustrated example of FIG. 14, is hingedly coupled to the storage case 950 via a hinge member 965. The storage case 950 defines a body that includes a primary interior cavity 952 and any number of additional interior cavities 954. In some examples, the body of the storage case 950 is generally solid with the exception of the cavities 952, 954. The storage case 950 may be constructed from a rigid material and may use a rubber and/or foam liner to surround the interior cavities 952, 954. Other examples of suitable materials are possible.

As illustrated in FIG. 14, when the foldable utensil 100 is positioned in the folded configuration, it may be placed into the primary interior cavity 952 for storage. The primary interior cavity 952 retains at least a portion of the foldable utensil 100 in the folded configuration, and thereby provides a clean, secure environment for the foldable utensil 100. The additional interior cavities 954 may be used to store additional foldable utensils, additional accessory working members, or any other components such as cleaning devices and the like. In the illustrated example, the lid 960 additionally includes a primary interior cavity 962 and any number of additional interior cavities 964 that are aligned with the cavities 952, 954 in the storage case 950. Accordingly, a portion of the foldable utensil 100 (and/or the additional components such as, for example, accessory working members) may be secured and/or retained by the lid 960.

In some examples, the storage case 950 may have cleaning and/or sterilization capabilities. For example, any number of the cavities 952, 954, 962, 964 may be coated with a cleaning or sterilization solution. Other examples are possible.

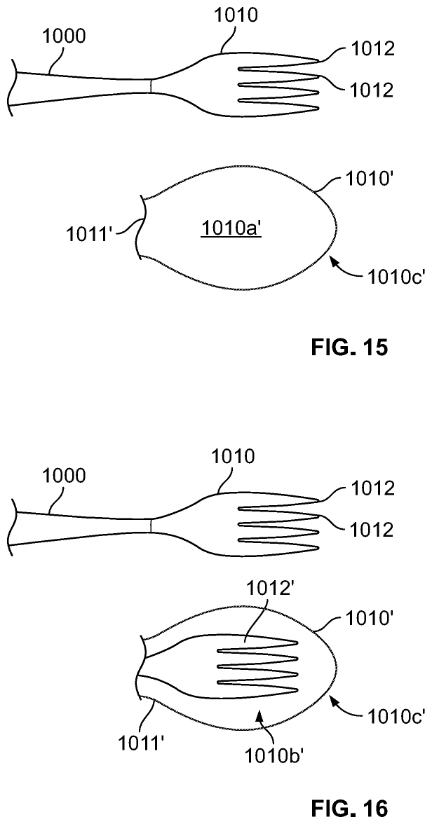

Turning to FIGS. 14 and 15, in some examples, a foldable utensil 1000 may be provided with an accessory working member that can be coupled directly with a portion of the foldable utensil. It is appreciated that the foldable utensil 1000 illustrated in FIGS. 14 and 15 may include similar features to the previously described foldable utensils and systems, and accordingly, elements illustrated in FIGS. 14 and 15 are designated by similar reference numbers indicated in the embodiments illustrated in FIGS. 1-13 increased by multiples of 100. Accordingly, these features will not be described in substantial detail. Further, it is appreciated that any of the elements described with regards to the previously described foldable utensils may be incorporated into the foldable utensil 1000.

In this example, the foldable utensil 1000 includes a first working member 1010 in the form of a fork or other member or utensil and additionally includes an accessory working member 1010′ in the form of a spoon or other utensil or component. The accessory working member 1010′ is in the form of a body having an upper side 1010a′, a lower side 1010b′, and a working end 1010c′. The accessory working member 1010′ further includes a neck portion 1011′ opposite from the working end 1010c′. As illustrated in FIG. 15, the lower side 1010b′ includes a recessed portion 1012′ having a shape and dimension that corresponds to the shape and dimension of the working member 1010.

In these examples, the recessed portion 1012′ has a shape that closely matches the shape of the tines 1012 of the working member 1010. Accordingly, the accessory working member 1010′ may be inserted on and/or over the working member 1010 via a snap or press-fit connection. In some examples, the recessed portion 1012′ may instead be a raised portion (not illustrated) that similarly couples with the tines 1012 of the working member 1010. In yet other examples, the tines 1012 of the working member 1010 may couple with recesses and/or indentations formed on the neck portion 1011′ of the accessory working member 1010′. In yet other examples, the tines 1012 of the working member 1010 may be inserted into an opening (not illustrated) formed on the neck portion 1012′ of the accessory working member 1010′. Other approaches to coupling the accessory working member 1010′ with the working member 1010 are possible.

In the illustrated example of FIGS. 14 and 15, the accessory working member 1010′ is in the form of a spoon. It is appreciated that in other examples, any number of utensils and/or tools that may be coupled the foldable utensil 1000 can be used such as, for example, a knife, a measuring cup, a strainer, a bowl, and the like. In some examples, such accessory working members may also be accommodated by a storage case having an interior cavity or cavities. Further, in some examples, an exterior surface of the storage case may have a corresponding recessed and/or raised portion that the accessory working member 1010′ may couple to.

It is appreciated that any number of additional alternatives may be possible. For example, in some examples, the foldable utensils described herein may have an inverted construction where the flexible member is adapted to surround and/or encapsulate an internal rigid structure (such as the first and second segments). Further, in some examples, the flexible member may or may not be a hollow member.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s).

1. A foldable utensil comprising:
a foldable stem member having a first end, a second end, and an elongated body extending along a longitudinal axis between the first end and the second end that includes at least a first segment and a second segment operably coupled with and foldable relative to the first segment;
a first insert insertable into the first segment and the second segment;
a working member operably coupled with and foldable relative to the second end of the foldable stem member, the working member having a profile that is curved and transverse relative to the longitudinal axis, the profile adapted to engage a consumable; and
a second insert insertable into the working member and the second end of the foldable stem member;
wherein the foldable utensil is positionable in a first, unfolded configuration and a second, folded configuration.

2. The foldable utensil of claim 1, wherein the elongated body of the foldable stem member comprises an exterior body defining an interior cavity, the foldable utensil further comprising a flexible member at least partially disposed within the interior cavity of the exterior body.

3. (canceled)

4. The foldable utensil of claim 2, wherein the first and the second segments are adapted to abut each other when the foldable utensil is positioned in the unfolded configuration.

5. The foldable utensil of claim 1, wherein the foldable stem member comprises a flexible member having integrally formed first and second segments and a first folding region at a first junction between the first and the second segments.

6. The foldable utensil of claim 2, wherein the flexible member is constructed from an elastic material, the flexible member being operably coupled with the working member, the flexible member configured to exert an elastic force on the working member.

7. The foldable utensil of claim 1, wherein the working member comprises at least one of:
a fork,
a spoon,
a spork,
a knife,
a splayd,
a spife, or
a hand tool.

8. A foldable utensil comprising:
a foldable stem member comprising an elongated body defining an interior cavity and having a first end and a second end, the elongated body including at least a first segment and a second segment operably coupled with and foldable relative to the first segment;
a working member operably coupled with and foldable relative to the second end of the elongated body; and
a flexible member at least partially disposed within the interior cavity and being operably coupled with the first end of the elongated body and the working member, the flexible member having a first end, a second end, and a length therebetween, the length of the flexible member being constructed from an elastic material having a first stiffness, the first and second ends of the flexible member being constructed from an elastic material having a second stiffness, the second stiffness being stiffer than the first stiffness;
wherein the foldable utensil is positionable in a first, unfolded configuration and a second, folded configuration.

9. (canceled)

10. The foldable utensil of claim 9, wherein the flexible member is removably coupled with the working member.

11. The foldable utensil of claim 8, wherein the first and the second segments are insertably coupled with each other.

12. The foldable utensil of claim 11, wherein the first and the second segments are adapted to abut each other when the foldable utensil is positioned in the unfolded configuration.

13. The foldable utensil of claim 8, wherein the flexible member is operably coupled with the working member, the flexible member configured to exert an elastic force on the working member.

14. The foldable utensil of claim 8, wherein the working member comprises at least one of:
a fork,
a spoon,
a spork,
a knife,
a splayd,
a spife, or
a hand tool.

15. A reusable utensil system comprising:
a foldable utensil comprising:
a foldable stem member having a first end, a second end, and an elongated body extending between the first end and the second end that includes at least a first segment and a second segment operably coupled with and foldable relative to the first segment;
a working member operably coupled with and foldable relative to the second segment of the foldable stem member;
wherein the foldable utensil is positionable in a first, unfolded configuration and a second, folded configuration; and
a storage case defining an interior cavity configured to retain the foldable utensil when the foldable utensil is positioned in the second, folded configuration.

16. The reusable utensil system of claim 15, wherein the working member is removably coupled with the second segment.

17. The reusable utensil system of claim 15, wherein the working member comprises at least one of:
a fork,
a spoon,
a spork,
a knife,
a splayd,
a spife, or
a hand tool.

18. The reusable utensil system of claim 16, wherein the interior cavity of the storage case is dimensioned to retain a plurality of working members.
